(19) United States
(12) Patent Application Publication
(10) Pub. No.: US 2018/0122571 A1
(43) Pub. Date: May 3, 2018

(54) METHOD FOR PRODUCING RFeB-BASED MAGNET

(71) Applicant: DAIDO STEEL CO., LTD., Nagoya-shi (JP)

(72) Inventor: Shinobu TAKAGI, Nagoya-shi (JP)

(21) Appl. No.: 15/798,138

(22) Filed: Oct. 30, 2017

(30) Foreign Application Priority Data
Oct. 31, 2016 (JP) 2016-212518
Sep. 14, 2017 (JP) 2017-176613

(51) Int. Cl. H01F 41/02

(52) U.S. Cl. CPC H01F 41/0253

(57) ABSTRACT

The present invention relates to a method for producing an RFeB-based magnet, including: an R^{H}-containing-substance adhesion step in which an R^{H}-containing slurry obtained by mixing an organic solvent with an R^{H}-containing powder that contains at least one heavy rare earth element R^{H} selected from the group consisting of Dy, Tb and Ho, is blown, in a form of dots or a line, onto a surface of a base material including an RFeB-based sintered magnet or RFeB-based hot-plastic worked magnet which contains a rare earth element R, Fe, and B, thereby adhering an R^{H}-containing substance to the surface of the base material; and a heating step in which the base material to which the R^{H}-containing substance has been adhered is heated to a predetermined temperature at which the heavy rare earth element R^{H} in the R^{H}-containing substance diffuses into the base material through grain boundaries of the base material.

### FIELD OF THE INVENTION

The present invention relates to a method for producing an RFeB-based magnet that contains R (rare earth element), Fe (iron), and B (boron). More specifically, the present invention relates to a method for producing an RFeB-based magnet, the method including a treatment (grain boundary diffusion treatment) in which at least one rare earth element selected from the group consisting of Dy (dysprosium), Tb (terbium) and Ho (holmium) (hereinafter, Dy, Tb and Ho are referred to as “heavy rare earth elements R^{H}”) is diffused to the vicinity of the surfaces of crystal grains contained in an RFeB-based sintered magnet obtained by subjecting a raw-material powder including a powder of an RFeB-based alloy to orientation in a magnetic field and then sintering the oriented raw-material powder or in an RFeB-based hot-plastic worked magnet obtained by subjecting the same raw-material powder to hot pressing and then to hot plastic working to thereby orient the crystal grains (see Non-Patent Document 1), the diffusion being caused to occur through the boundaries of the crystal grains.

### BACKGROUND OF THE INVENTION

An RFeB-based magnet was found by Sagawa et al. in 1982, and has an advantage that many magnetic properties including residual magnetic flux density are far higher than those of conventional permanent magnets. Accordingly, the RFeB-based magnet is used in various products such as the drive motors of hybrid cars and electric cars, motors for electrically assisted bicycles, industrial motors, voice coil motors of hard disk drives and the like, speakers, headphones, and permanent magnet type magnetic resonance diagnostic devices.

Early RFeB-based magnets had the defect of being relatively low in coercive force H_{cJ} among various magnetic properties. However, it was thereafter found that the coercive force is improved by making a heavy rare earth element R^{H} be present inside the RFeB-based magnets. The coercive force is a force that resists the inversion of magnetization which occurs when a magnetic field having a direction opposed to the direction of the magnetization is applied to the magnet. It is considered that the heavy rare earth element R^{H} hinders the inversion of magnetization and thus has the effect of increasing the coercive force.

Meanwhile, increasing the content of a heavy rare earth element R^{H} in an RFeB-based magnet poses a problem in that this magnet has a reduced residual magnetic flux density Bᵣ and hence a reduced maximum energy product (BH)ₘₐₓ. In addition, since the heavy rare earth elements R^{H} are expensive and rare resources and are yielded only in localized regions, it is not desirable to increase the content of the heavy rare earth elements R^{H}, also from the standpoint of stably supplying RFeB-based magnets to the market at low cost.

Accordingly, a grain boundary diffusion treatment is conducted in order to increase the coercive force while keeping the content of the heavy rare earth element R^{H} low (see, for example, Patent Document 1). In the grain boundary diffusion treatment, an R^{H}-containing substance that contains a heavy rare earth element R^{H} is adhered to a surface of an RFeB-based sintered magnet or RFeB-based hot-plastic worked magnet and this magnet is heated, thereby causing the heavy rare earth element R^{H} to penetrate to the inside of the magnet through grain boundaries. Thus, the heavy rare earth element R^{H} is diffused only to the vicinity of the surfaces of crystal grains. Hereinafter, an RFeB-based sintered magnet or RFeB-based hot-plastic worked magnet which has not undergone the grain boundary diffusion treatment is referred to as “base material”. A decrease in coercive force occurs when the inversion of magnetization occurs in the vicinity of the surfaces of crystal grains and then spreads over the whole crystal grains. Consequently, by increasing the concentration of a heavy rare earth element R^{H} in the vicinity of the surfaces of crystal grains, the inversion of magnetization can be inhibited and the coercive force can be enhanced. Meanwhile, since the heavy rare earth element R^{H} localizes only in the vicinity of the surfaces (grain boundaries) of crystal grains, the overall content thereof can be kept low. As a result, not only the residual magnetic flux density and the maximum energy product can be prevented from decreasing, but also RFeB-based magnets can be stably supplied to the market at low cost.

There are various methods for adhering an R^{H}-containing substance to a surface of a base material when performing the grain boundary diffusion treatment. For example, Patent Document 1 describes a method in which an R^{H}-containing slurry constituted of a mixture of an organic solvent and a powder including a heavy rare earth element R^{H} is ejected from nozzles toward a surface of a base material to thereby adhere an R^{H}-containing substance to the base material surface.

Patent Document 1: JP-A-2015-065218

Patent Document 2: JP-A-2006-019521

Patent Document 3: WO 2011/136223

Non-Patent Document 1: “Development of Dy-omitted Nd—Fe—B-based hot worked magnet by using a rapidly quenched powder as a raw material”, written by Hioki Keiko and Hattori Atsushi, Sokeizai, Vol. 52, No. 8, pages 19 to 24, General Incorporation Foundation Sokeizai Center, published on August, 2011.

### SUMMARY OF THE INVENTION

Patent Document 1 indicates that from the standpoint of preventing the heavy rare earth element R^{H} from being wasted by consuming the element in an amount beyond a necessary amount, it is desirable to dispose a large number of nozzles facing the base material surface to thereby evenly adhere an R^{H}-containing substance to the base material surface without forming an unnecessarily thick portion. Actually, however, it is difficult to eject the R^{H}-containing substance from the nozzles at the same rate (feed amount per unit time period), and the feed amount of the R^{H}-containing substance undesirably varies from nozzle to nozzle. There are hence portions where the R^{H}-containing substance adheres in an unnecessarily large amount. As a result, in these portions, the R^{H} penetrates not only to the vicinity of grain boundaries but also to the inside of crystal grains, thereby reducing the magnetic properties. Consequently, the magnet as a whole does not exhibit even magnetic properties. In addition, the heavy rare earth element R^{H} is wasted.

An object of the present invention is to provide a method for producing an RFeB-based magnet, in which not only a grain boundary diffusion treatment can be performed so that a heavy rare earth element R^{H} is caused to penetrate in the whole base material (magnet) as evenly as possible to thereby produce a magnet that is homogeneous as a whole but also the magnet can be produced without wasting the heavy rare earth element R^{H}.

Namely, the present invention relates to the following items (1) to (7).

(1) A method for producing an RFeB-based magnet, the method including:

an R^{H}-containing-substance adhesion step in which an R^{H}-containing slurry obtained by mixing an organic solvent with an R^{H}-containing powder that contains at least one heavy rare earth element R^{H}selected from the group consisting of Dy, Tb and Ho, is blown, in a form of dots or a line, onto a surface of a base material including an RFeB-based sintered magnet or RFeB-based hot-plastic worked magnet which contains a rare earth element R, Fe, and B, thereby adhering an R^{H}-containing substance to the surface of the base material; and

a heating step in which the base material to which the R^{H}-containing substance has been adhered is heated to a predetermined temperature at which the heavy rare earth element R^{H} in the R^{H}-containing substance diffuses into the base material through grain boundaries of the base material.

(2) The method for producing an RFeB-based magnet according to (1), in which the R^{H}-containing substance is adhered in a form of a plurality of dots or lines to the surface of the base material.
(3) The method for producing an RFeB-based magnet according to (1) or (2), in which the R^{H}-containing substance is adhered in an areal proportion of 31.4% or higher, the areal proportion being a proportion of an area of portions occupied by the R^{H}-containing substance in the base material surface to which the R^{H}-containing substance has been adhered.
(4) The method for producing an RFeB-based magnet according to any one of (1) to (3), in which the R^{H}-containing substance is adhered in the form of dots to the surface of the base material.
(5) The method for producing an RFeB-based magnet according to (4), in which the dots of the R^{H}-containing substance adhered to the surface of the base material are linearly arranged.
(6) The method for producing an RFeB-based magnet according to any one of (1) to (5), in which the base material surface to which the R^{H}-containing substance is to be adhered is a curved surface.
(7) The method for producing an RFeB-based magnet according to (6), in which the curved surface is a concave surface.

In the method for producing an RFeB-based magnet according to the invention, an R^{H}-containing slurry is blown, in the form of dots or a line, onto a surface of a base material. As a result, an R^{H}-containing substance constituted of or formed from the R^{H}-containing slurry adheres, in the form of dots or lines, to the base material surface. The dots or lines of the R^{H}-containing substance which have adhered to the base material surface may have been separated from each other (there may be uncoated portions between the dots or lines of the R^{H}-containing substance), or the dots or lines of the R^{H}-containing substance may have been connected to each other to form a dotted or striped pattern with variable concentrations (a state in which portions coated with a small amount of the R^{H}-containing slurry are present among the dots or lines). From the standpoint of preventing the use amount of the heavy rare earth element R^{H} from increasing, it is desirable that the dots or lines of the R^{H}-containing substance should have been separated from each other.

The RFeB-based sintered magnet and the RFeB-based hot-plastic worked magnet each include R, Fe, and B as main constituent elements, and may contain other elements such as Co, Ni, Al, and Cu.

Experiments made by the present inventor revealed that an RFeB-based magnet obtained by adhering an R^{H}-containing substance to a surface of a base material by blowing an R^{H}-containing slurry not to the whole base material surface but in the form of dots or a line and then performing a grain boundary diffusion treatment has a higher coercive force than the base material which has not undergone the grain boundary diffusion treatment. This is because in the heating step, the heavy rare earth element R^{H} diffuses from the R^{H}-containing substance, which has been adhered in the form of dots or lines to the base material surface, also in directions parallel with the base material surface. Thus, the R^{H}-containing slurry is prevented from being used in an unnecessarily large amount, while attaining a higher coercive force than that of the base material, and the heavy rare earth element R^{H} can hence be prevented from being wasted.

Furthermore, according to experiments made by the present inventor, by regulating the areal proportion, which is the proportion of the area of the portions occupied by the R^{H}-containing substance in the base material surface to which the R^{H}-containing substance has been adhered, to 31.4% or higher, a coercive force equal to that attained when the R^{H}-containing substance is adhered to the whole base material surface can be obtained. This is thought to be because by regulating the areal proportion to such a value, the heavy rare earth element R^{H} is made to diffuse to all directions parallel with the base material surface (even to the portions where the R^{H}-containing substance is not adhered), thereby obtaining the same effect as in the case where the R^{H}-containing substance has been adhered to the whole base material surface. The region where the R^{H}-containing substance is adhered in the form of dots or lines need not be all the surfaces of the base material. For example, in the case of a base material which is in the shape of a plate (rectangular parallelepiped), the method generally employed hitherto is to adhere an R^{H}-containing substance only to one surface or to two opposed surfaces. In such a case, by adhering the R^{H}-containing substance in the form of dots or lines to the one or two surfaces in an areal proportion of 31.4% or higher, the same effect as in the case of adhering the R^{H}-containing substance to the whole of the one or two surfaces is obtained.

With respect to the form in which the R^{H}-containing substance is adhered to the base material surface, dots are more desirable than lines from the standpoint that the amount of the heavy rare earth element R^{H} can be reduced even more effectively.

In the case of adhering the R^{H}-containing substance in the form of dots, it is desirable that the dots of the R^{H}-containing substance should be linearly arranged. Such disposition of the R^{H}-containing substance can be easily attained by intermittently ejecting the R^{H}-containing slurry from a nozzle which faces the base material surface, while linearly moving the nozzle relative to the surface in a direction parallel with the surface.

Patent Document 3 describes a method in which the technique of screen printing is used to apply an R^{H}-containing slurry to a surface of a base material. In this method, a screen is stretched on a surface of a base material, and the R^{H}-containing slurry is supplied to the surface of the screen. Thereafter, the screen surface is scraped with a squeegee, thereby passing the R^{H}-containing slurry through penetrable areas within the screen and applying the R^{H}-containing slurry to the base-material surface. However, this method of Patent Document 3 is intended for application to base-material surfaces which are flat, and it is difficult to apply an R^{H}-containing slurry to a curved base-material surface by the method. In contrast, by the method for producing an RFeB-based magnet according to the present invention, an R^{H}-containing substance can be adhered to a surface of a base material, regardless of whether the surface is flat or curved, by blowing the R^{H}-containing slurry in the form of dots or a line. In particular, the method for producing an RFeB-based magnet according to the present invention is suitable for adhering an R^{H}-containing substance to curved base-material surfaces, application to which by the method of Patent Document 3 has been difficult. The curved surface to which an R^{H}-containing substance is to be adhered may be either a convex surface or a concave surface. In the case of a base material having both a convex surface and a concave surface, the R^{H}-containing substance may be adhered to both surfaces or to only either of the two surfaces.

According to the method of the present invention for producing an RFeB-based magnet, not only a grain boundary diffusion treatment can be performed so that a heavy rare earth element R^{H} is caused to penetrate in the whole base material (magnet) as evenly as possible to thereby produce a magnet that is homogeneous as a whole but also the magnet can be produced without wasting the heavy rare earth element R^{H}.

### BRIEF DESCRIPTION OF THE DRAWING

FIGS. 1A to 1D are diagrammatic views which show one embodiment of the method for producing an RFeB-based magnet according to the present invention.

FIG. 2 is a diagrammatic view illustrating the configuration of an R^{H}-containing-slurry feeder for use in embodiments of the method for producing an RFeB-based magnet according to the present invention.

FIGS. 3A to 3F are plan views illustrating examples of patterns according to which an R^{H}-containing substance is disposed on a surface of a base material.

FIGS. 4A and 4B are plan views illustrating examples of patterns according to which an R^{H}-containing substance is disposed on a surface of a base material.

FIG. 5 is a photograph showing an example in which an R^{H}-containing substance has been adhered to a surface of a base material.

FIG. 6 is a plan view illustrating the pattern used in Example 9, according to which an R^{H}-containing substance was disposed on surfaces of a base material.

FIGS. 7A and 7B are photographs showing the convex surface (FIG. 7A) and concave surface (FIG. 7B) of the base material to which the R^{H}-containing substance had been adhered in Example 9.

### DETAILED DESCRIPTION OF THE INVENTION

Embodiments of the method for producing an RFeB-based magnet according to the present invention will be described with reference to the accompanying drawings.

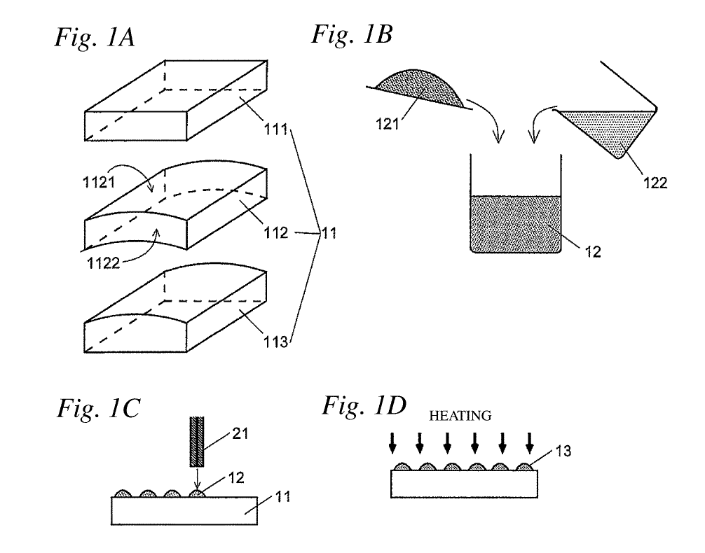

FIGS. 1A to 1D are diagrammatic views illustrating steps of one embodiment of the method for producing an RFeB-based magnet. First, a base material 11 including an RFeB-based sintered magnet or an RFeB-based hot-plastic worked magnet is prepared by a known method (FIG. 1A). The RFeB-based sintered magnet may be produced by a pressing method in which an RFeB-based alloy powder as a raw material is press-molded, while being oriented with a magnetic field, and then sintered, or may be produced by a PLP (press-less process) method in which an RFeB-based alloy powder is oriented with a magnetic field in a mold, without being press-molded, and is then sintered as such, as described in Patent Document 2. The RFeB-based hot-plastic worked magnet can be produced by the method described in Non-Patent Document 1. The base material 11 can have any of various shapes such as, for example, the shape of a rectangular parallelepiped (reference numeral 111), a base material which as a whole has the shape of a bow (reference numeral 112), and a base material having the shape of a rectangular parallelepiped in which only one surface thereof has been changed to a bow-shaped curved surface protrudent upward (reference numeral 113; hereinafter referred to as “shape with one bow-shaped surface”), as shown in FIG. 1A. A base material having a shape having one or more curved surfaces, such as the base materials designated by reference numerals 112 and 113, may be produced by the PLP method using a mold corresponding to the shape, and this method is desirable from the standpoint that there is no need of performing machining for forming the shape (surface finishing suffices).

Next, an R^{H}-containing slurry 12 is prepared (FIG. 1B). The R^{H}-containing slurry 12 is produced by mixing an R^{H} alloy powder 121 containing a heavy rare earth element R^{H} with an organic solvent 122. In the Examples, which will be given later, a powder of a TbNiAl alloy including Tb, Ni, and Al in a mass ratio of 92:4:4 was used as the R^{H} alloy powder 121. Here, Dy or Ho may be used in place of the Tb, or two or more of Dy, Tb, and Ho may be used. Ni and Al are not essential in the present invention, although these elements serve to lower the melting point of the alloy. Consequently, a metal constituted of only heavy rare earth element R^{H} may be used as the R^{H} alloy powder 121, or an R^{H} alloy powder containing elements other than Ni and/or Al may be used. In the Examples, which will be given later, two silicones (so-called silicone grease and silicone oil) differing in viscosity were mixed together to regulate the viscosity and this mixture was used as the organic solvent 122. The viscosity of the organic solvent 122 was regulated so that the R^{H}-containing slurry 12 was ejectable from the nozzle 21, which will be described next, and that the R^{H}-containing slurry 12 which had been blown in the form of dots or a line onto a surface of a base material 11 formed dots or lines that did not flow on the surface to join with adjacent ones. Organic solvents other than silicones may be used.

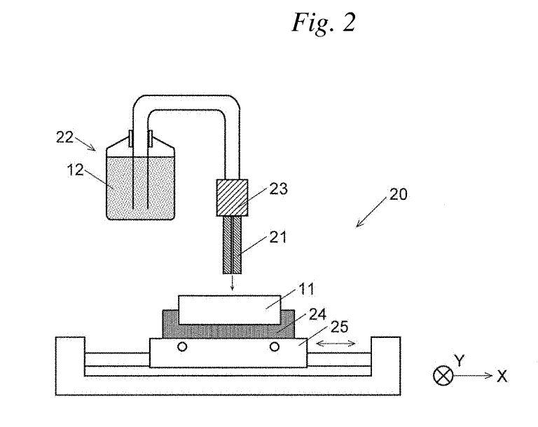

Next, the R^{H}-containing slurry 12 is blown, in the form of dots or a line, onto a surface of a base material 11 by the R^{H}-containing-slurry feeder 20 shown in FIG. 2 (FIG. 1C). The R^{H}-containing-slurry feeder 20 includes one nozzle 21, a reservoir tank 22 for retaining the R^{H}-containing slurry therein, an R^{H}-containing-slurry sender 23 which sucks the R^{H}-containing slurry 12 from the reservoir tank 22 and intermittently sends out the R^{H}-containing slurry 12 to the nozzle 21, a base material holding part 24 which holds the base material 11 so that the base material 11 faces the nozzle 21, and a moving part 25 which moves the horizontal-direction relative positions of the nozzle 21 and base material holding part 24.

The R^{H}-containing-slurry sender 23 has a pneumatic or electromagnetic-solenoid type actuator, and the actuator pushes out the R^{H}-containing slurry 12 toward the nozzle 21 when a valve element or piston moves upon signal transmission from a controller of the R^{H}-containing-slurry sender 23 to the actuator. A piezoelectric element may be used in the actuator. These examples are each for blowing the R^{H}-containing slurry 12 in the form of dots onto a surface of a base material 11. However, the R^{H}-containing slurry 12 can be blown in the form of a line onto a surface of a base material 11, for example, by using an R^{H}-containing-slurry sender 23 which enables the R^{H}-containing slurry to be continuously sent out from the nozzle 21 by opening a valve.

The moving part 25 used in this embodiment is one which moves the base material holding part 24. However, the moving part 25 may be one which moves the nozzle 21 or one which moves both the nozzle 21 and the base material holding part 24. Hereinafter, the wording “the nozzle 21 is moved” means that the position of the nozzle 21 relative to the base material 11 held on the base material holding part 24 is moved, and this operation includes the case where either the nozzle 21 or the base material holding part 24 is moved. The moving part 25 shown here as an example has a mechanism which moves the base material holding part 24 in two directions, i.e., direction X, which is a horizontal direction, and direction Y, which is a horizontal direction perpendicular to direction X. Thus, the base material holding part 24 can be moved to any desired positions within an arbitrary planar range.

The surface of the base material 11 to which the R^{H}-containing slurry 12 is adhered may be a flat surface or a curved surface.

In the case where the organic solvent 122 in the R^{H}-containing slurry 12 blown onto the surface of the base material 11 is a volatile solvent, the organic solvent 122 vaporizes to leave solid matter on the surface of the base material 11. In the case where the organic solvent 122 is a nonvolatile solvent, the R^{H}-containing slurry remains as such on the surface of the base material 11. In either case, an R^{H}-containing substance 13 which contains the heavy rare earth element R^{H} adheres in the form of dots or lines to the surface of the base material 11. When blowing the R^{H}-containing slurry in the form of dots or lines onto the surface of the base material 11, the R^{H}-containing slurry is blown so that the dots or lines are separated from each other to some degree. As a result, the dots or lines of the R^{H}-containing substance 13 which have adhered to the surface of the base material 11 have also been disposed in the state of having been separated from each other so as to leave a space therebetween.

The base material 11 to which the R^{H}-containing substance 13 has adhered is heated to a predetermined temperature together with the R^{H}-containing substance 13 (FIG. 1D). The predetermined temperature is a temperature at which the heavy rare earth element R^{H} in the R^{H}-containing substance 13 diffuses into the base material 11 through grain boundaries of the base material 11, and typically is 700-1,000° C. After the heavy rare earth element R^{H} is thus diffused into the base material 11 through grain boundaries, this base material 11 is subjected, according to need, to an aging treatment (treatment in which the base material 11 is heated at a relatively low temperature of about 500° C.), a grinding treatment for removing the residue of the R^{H}-containing substance 13 remaining on the surface of the base material 11, or a magnet shaping treatment. Thus, an RFeB-based magnet as a final product is obtained.

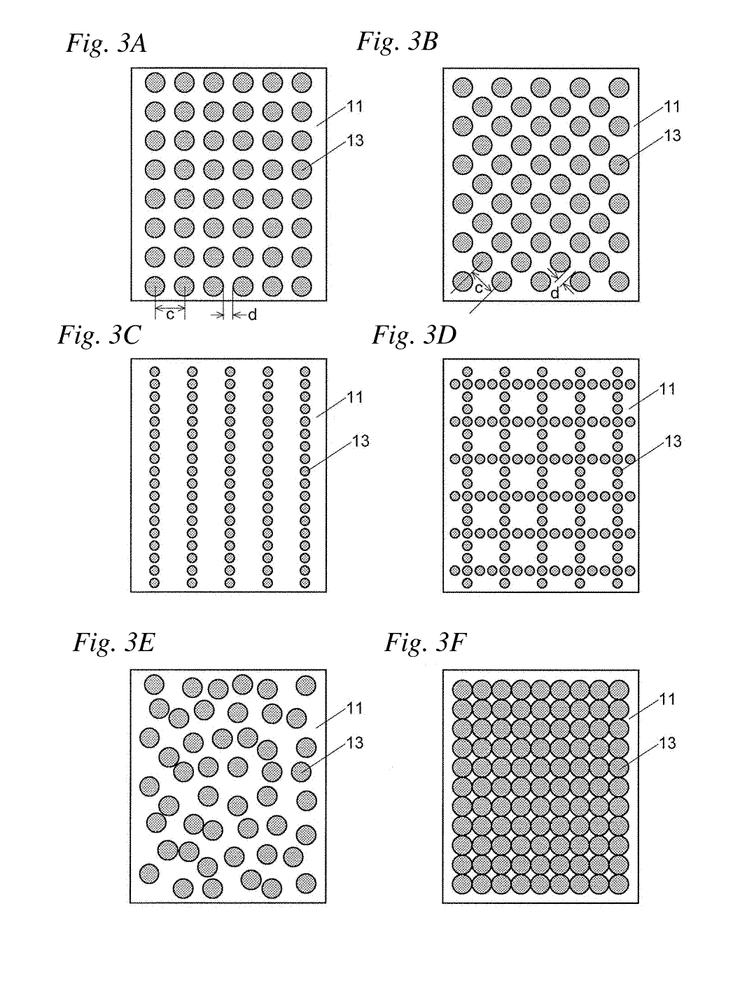

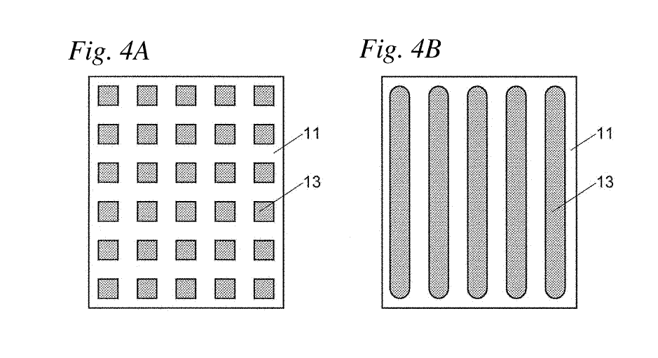

Shown in FIGS. 3A to 3F and FIGS. 4A and 4B are examples of patterns according to which an R^{H}-containing substance 13 is disposed on a surface of a base material 11. The views of FIGS. 3A to 3F each show an example in which an R^{H}-containing substance 13 has been disposed in the plan-view shape of circular dots. In the example of FIG. 3A, an R^{H}-containing substance 13 has been disposed in a square lattice arrangement. The R^{H}-containing substance 13 may be disposed in a rectangular lattice arrangement in place of the square lattice arrangement. Such disposition can be attained by blowing the R^{H}-containing slurry 12 intermittently and periodically onto a surface of a base material 11 while moving the nozzle 21 in the vertical direction or transverse direction of the drawing, to thereby form one row of dots of an R^{H}-containing substance 13, and then moving the nozzle 21 in a direction perpendicular to the row to repeat the same operation. Meanwhile, in the example of FIG. 3B, an R^{H}-containing substance 13 has been disposed so that dots thereof have been arranged in rows along the vertical direction of the drawing at regular intervals and that the dots in the rows which are adjacent along the transverse direction have been dislocated by one-half the period. This disposition is hereinafter called “zigzag” arrangement. Such a disposition is attained basically by the same method as for FIG. 3A, specifically in such a manner that when blowing the R^{H}-containing slurry 12 and forming each of the second and succeeding rows, the position of the nozzle 21 is shifted by one-half the period in the direction of the row.

The example of FIG. 3C is a modification of FIG. 3A, and the intervals between the dots of an R^{H}-containing substance 13 in the same row are shorter than the intervals between the rows. Although such a disposition is similar to the disposition of lines, the disposition in this example is capable of more reducing the use amount of the heavy rare earth element R^{H} than in the case of the disposition of lines because there are spaces between the dots of the R^{H}-containing substance 13 in the same row. In the example of FIG. 3D, rows of dots of an R^{H}-containing substance 13 have been formed in each of the vertical direction and transverse direction of the drawing at intervals which are equal to the dimension of three dots arranged in a row. The intervals between the rows may be a distance not equal to the dimension of three dots of R^{H}-containing substance.

In the example of FIG. 3E, dots of an R^{H}-containing substance 13 have been randomly disposed. In the example of FIG. 3F, dots of an R^{H}-containing substance 13 have been formed on a surface of a base material 11 more densely than in the other examples, and the dots of an R^{H}-containing substance 13 are in contact with each other.

Shown in FIGS. 4A and 4B are examples in which an R^{H}-containing substance 13 is disposed in a plan-view shape which is not circular. FIG. 4A shows an R^{H}-containing substance 13 disposed in the shape of square dots. The R^{H}-containing substance 13 can have, besides the square shape, any of various planar shapes such as, for example, rectangular and other quadrilateral shapes, polygonal shapes other than quadrilateral shapes, such as triangular and hexagonal shapes, and elliptic shapes, in accordance with the shape of the nozzle 21. In the example of FIG. 4B, an R^{H}-containing substance 13 has been disposed in the plan-view shape of lines, and these lines of the R^{H}-containing substance 13 have been disposed in parallel in a large number.

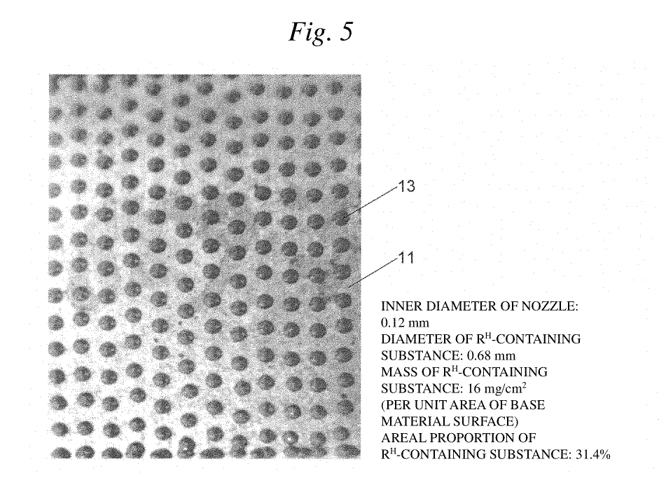

FIG. 5 shows, by means of a photograph, an example in which an R^{H}-containing substance 13 has been adhered to a surface of a base material 11. In this example, a nozzle 21 having an inner diameter of 0.12 mm was used. The R^{H} alloy powder 121 used was the powder of TbNiAl alloy described hereinabove including Tb, Ni and Al in a mass ratio of 92:4:4. The organic solvent 122 was a solvent obtained by mixing a silicone grease and a silicone oil in a mass ratio of 10:15. The R^{H}-containing slurry 12 was a slurry obtained by mixing the R^{H} alloy powder 121 and the organic solvent 122 in a mass ratio of 75:25. All the dots of an R^{H}-containing substance 13 adhered in a large number to the surface of the base material 11 had substantially the same diameter, which was 0.68 mm. The amount of the R^{H}-containing substance 13 adhered per unit area of the whole surface of the base material 11 was 16 mg/cm². The areal proportion, which is the proportion of the area of the portions occupied by the R^{H}-containing substance 13 in the whole surface of the base material 11, was 31.4%.

Next, samples of Examples and Reference Examples were produced under multiple sets of conditions in this embodiment, and were examined for magnetic property. The results thereof are shown. In this experiment, the samples were produced using base materials having the shape with one bow-shaped surface (reference numeral 113 in FIG. 1A) which had been produced in the same lot and had the same size. When producing each of the samples of the Examples, an R^{H}-containing substance was adhered, in the plan-view shape of circular dots, to the bow-shaped curved surface of the base material. In each of the Reference Examples, the R^{H}-containing slurry was applied to the flat surface facing the bow-shaped curved surface, using the screen printing method described in Patent Document 3, thereby evenly adhering an R^{H}-containing substance to the whole flat surface. The reason why the R^{H}-containing slurry was applied to the flat surface in each Reference Example is that it is difficult to apply the R^{H}-containing slurry to curved surfaces by the screen printing method. The heating temperature in the grain boundary diffusion treatment was 900° C. The other production conditions vary from sample to sample, and are hence explained below.

In Table 1 are shown the production conditions, which vary from sample to sample, and the magnetic properties of each sample determined at room temperature. The dot interval c and the gap d in the table are defined as the interval between one dot of the R^{H}-containing substance 13 and the nearest dot of the R^{H}-containing substance 13 and the dimension of the gap therebetween (the portion where the R^{H}-containing substance is not present), respectively, as shown in FIG. 3A in the case where the disposition of the R^{H}-containing substance 13 is a square lattice arrangement and in FIG. 3B in the case where the disposition thereof is a zigzag arrangement. The “amount applied” means the amount of the R^{H}-containing substance 13 applied per unit area of the surface to which the R^{H}-containing substance 13 has been applied. The “areal proportion” means the proportion of the area of the portions occupied by the R^{H}-containing substance in the base material surface to which the R^{H}-containing substance has adhered.

TABLE 1

| | | | | | | | | Magnetic | |
|---|---|---|---|---|---|---|---|---|---|
| | Production conditions | | | | | | | properties | |
| | | Diameter | | | | | | Residual | |
| | Diameter | of R^{H}- | | Disposition | | | | magnetic | Coercive |
| | of | containing | Amount | of R^{H}- | Dot | | Areal | flux density | force |
| | nozzle | substance | applied | containing | interval c | Gap d | proportion | Bᵣ | H_{cJ} |
| | [mm] | [mm] | [mg/cm²] | substance | [mm] | [mm] | [%] | [kG] | [kOe] |
| Example 1 | 0.12 | 0.68 | 16 | square | 1.2 | 0.5 | 31.4 | 13.9 | 25.0 |
| Example 2 | 0.12 | 0.49 | 16 | square | 0.6 | 0.1 | 65.7 | 14.0 | 25.0 |
| Example 3 | 0.24 | 1.2 | 16 | zigzag | 1.7 | 0.5 | 48.9 | 13.9 | 24.9 |
| Example 4 | 0.39 | 2.4 | 16 | zigzag | 3.0 | 0.6 | 43.5 | 13.9 | 24.6 |
| Example 5 | 0.39 | 2.4 | 16 | zigzag | 5.3 | 2.9 | 26.1 | 14.1 | 21.0 |
| Example 6 | 0.39 | 2.4 | 16 | zigzag | 6.1 | 3.6 | 13.0 | 14.1 | 16.2 |
| Example 7 | 0.12 | 0.45 | 16 | square | 1.2 | 0 | 100 | 13.9 | 24.3 |
| Example 8 | 0.12 | 0.45 | 24 | square | 1.2 | 0 | 100 | 13.8 | 24.9 |
| Reference | — | — | 16 | — | — | — | 100 | 13.9 | 23.6 |
| Example 1 | | | | | | | | | |
| Reference | — | — | 32 | — | — | — | 100 | 13.8 | 24.8 |
| Example 2 | | | | | | | | | |

It can be seen from the results of the experiment that in each Example, a coercive force higher than the coercive force of the base material, which was 13 kOe, was obtained. In Examples 1 to 4, 7 and 8, in which the areal proportions were higher than 31.4%, coercive forces higher than that of Reference Example 1 were obtained, these coercive forces being equal to that of Reference Example 2, in which the amount applied was larger than in these Examples. In particular, it is remarkable that Examples 1 to 4, although the dots had been disposed so as to leave gaps therebetween, attained coercive forces which were equal to or higher than those of the Reference Examples, in each of which an R^{H}-containing substance 13 had been evenly applied over the base material surface.

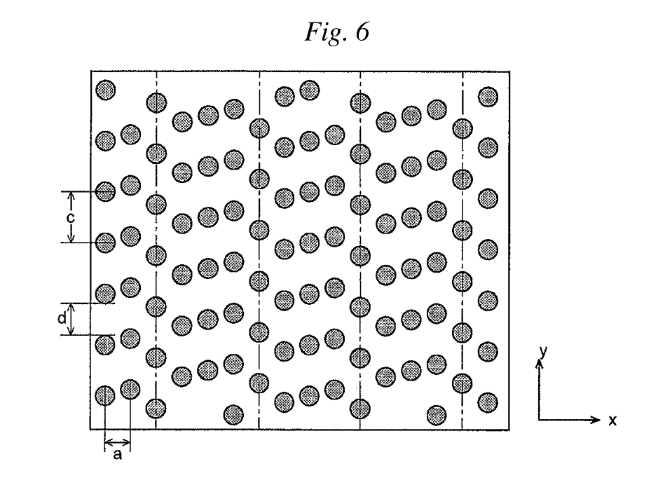

Next, Example 9 is explained, in which use was made of a base material that as a whole had the shape of a bow (the base material indicated by reference numeral 112 in FIG. 1A). In Example 9, an R^{H}-containing substance 13 was adhered, so as to result in the pattern shown by the plan view of FIG. 6, to both the convex surface 1121 and concave surface 1122 (see FIG. 1A) possessed by the bow-shaped base material 112. In this pattern, dots of the R^{H}-containing substance 13 have been arranged in rows along the vertical direction (y direction) of FIG. 6 at intervals c (gap between dots, d), the rows of dots of the R^{H}-containing substance 13 having been disposed along the transverse direction (x direction) of FIG. 6 at intervals a. The basic positions of dots along the y direction have been dislocated by c/8 between the adjacent rows of dots. Consequently, any two rows which are apart from each other along the x direction by eight periods are equal in the y-direction positions of dots. It is, however, noted that the dots of the R^{H}-containing substance 13 have been disposed so that the positions of dots in every fourth row (only the rows indicated by the dot-and-dash lines in FIG. 6) are dislocated from the basic positions by c/2 in the y direction. Thus, the rows of dots which extend in a direction inclined from the x direction by arctan (⅛) (about 7°) and which are formed in the case of disposing dots in the basic positions only are disordered. Namely, dots can be disposed scatteringly.

In Example 9, a nozzle 21 having a diameter of 0.21 mm was used so that dots of the R^{H}-containing substance 13 which had a diameter of 0.8 mm were formed on the surfaces of the base material 112. The y-direction intervals between dots were regulated to 2 mm, with the y-direction gap d between dots being 1.2 mm, and the intervals a between the rows of dots extending along the x-direction were regulated to 0.6 mm. The R^{H}-containing substance 13 was applied to each surface of the base material 112 in an amount of 16 mg/cm², and the areal proportion, which is the proportion of the area of the portions occupied by the R^{H}-containing substance 13 in the surface of the base material 112, was 31.6%. The R^{H}-containing substance 13 used here was the same as in Examples 1 to 8.

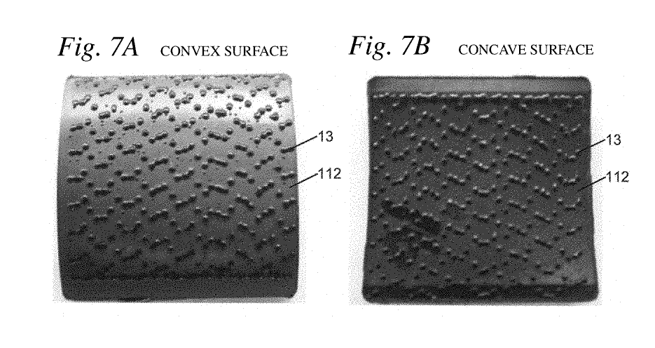

In FIGS. 7A and 7B, the convex surface 1121 (FIG. 7A) and concave surface 1122 (FIG. 7B) of the base material 112 to which dots of the R^{H}-containing substance 13 had been adhered are shown by photographs. After dots of the R^{H}-containing substance were thus adhered to both the convex surface 1121 and the concave surface 1122, the base material 112 was heated to a temperature of 900° C. as in Examples 1 to 8, thereby obtaining a sample of Example 9. The sample obtained was examined for magnetic property. As a result, this sample was found to have a residual magnetic flux density Bᵣ of 13.9 kG and a coercive force H_{cJ} of 22.3 kOe, these values being substantially the same as those of the other Examples.

Although an R^{H}-containing substance 13 was adhered to both the convex surface 1121 and concave surface 1122 of a bow-shaped base material 112 in Example 9, the R^{H}-containing substance 13 may be adhered to the convex surface 1121 only or to the concave surface 1122 only. Furthermore, the pattern according to which dots of the R^{H}-containing substance 13 are adhered to the convex surface 1121 or the concave surface 1122 is not limited to the example shown in FIG. 6, and any of various patterns including those shown in FIGS. 3A to 3F and FIGS. 4A and 4B can be employed. The pattern of dots of an R^{H}-containing substance 13 shown in FIG. 6 may be applied to base materials of other shapes, e.g., a base material of a flat plate shape and a base material having a shape with one bow-shaped surface. It is also possible to adhere dots of an R^{H}-containing substance 13 to a convex surface and/or a concave surface of any of base materials of various shapes, in accordance with a pattern different from that shown in FIG. 6.

The present application is based on Japanese patent application No. 2016-212518 filed on Oct. 31, 2016 and Japanese patent application No. 2017-176613 filed on Sep. 14, 2017, and the contents of which are incorporated herein by reference.

### DESCRIPTION OF REFERENCE NUMERALS AND SIGNS

11, 111, 112, 113 . . . Base material

1121 . . . Convex surface

1122 . . . Concave surface

12 . . . R^{H}-containing slurry

121 . . . R^{H}alloy powder

122 . . . Organic solvent

13 . . . R^{H}-containing substance

20 . . . R^{H}-containing-slurry feeder

21 . . . Nozzle

22 . . . Reservoir tank

23 . . . R^{H}-containing-slurry sender

24 . . . Base material holding part

25 . . . Moving part

What is claimed is:

1. A method for producing an RFeB-based magnet, the method comprising:
an R^{H}-containing-substance adhesion step in which an R^{H}-containing slurry obtained by mixing an organic solvent with an R^{H}-containing powder that contains at least one heavy rare earth element R^{Hv}selected from the group consisting of Dy, Tb and Ho, is blown, in a form of dots or a line, onto a surface of a base material comprising an RFeB-based sintered magnet or RFeB-based hot-plastic worked magnet which contains a rare earth element R, Fe, and B, thereby adhering an R^{H}-containing substance to the surface of the base material; and
a heating step in which the base material to which the R^{H}-containing substance has been adhered is heated to a predetermined temperature at which the heavy rare earth element R^{H} in the R^{H}-containing substance diffuses into the base material through grain boundaries of the base material.

2. The method for producing an RFeB-based magnet according to claim 1, wherein the R^{H}-containing substance is adhered in a form of a plurality of dots or lines to the surface of the base material.

3. The method for producing an RFeB-based magnet according to claim 1, wherein the R^{H}-containing substance is adhered in an areal proportion of 31.4% or higher, the areal proportion being a proportion of an area of portions occupied by the R^{H}-containing substance in the base material surface to which the R^{H}-containing substance has been adhered.

4. The method for producing an RFeB-based magnet according to claim 1, wherein the R^{H}-containing substance is adhered in the form of dots to the surface of the base material.

5. The method for producing an RFeB-based magnet according to claim 4, wherein the dots of the R^{H}-containing substance adhered to the surface of the base material are linearly arranged.

6. The method for producing an RFeB-based magnet according to claim 1, wherein the base material surface to which the R^{H}-containing substance is to be adhered is a curved surface.

7. The method for producing an RFeB-based magnet according to claim 6, wherein the curved surface is a concave surface.
